(19) United States
(12) Patent Application Publication
(10) Pub. No.: US 2023/0402758 A1
(43) Pub. Date: Dec. 14, 2023

(54) Dual-feed circular patch antenna system with isolated ports

(71) Applicant: Topcon Positioning Systems, Inc., Livermore, CA (US)

(72) Inventors: Stanislav Borisovich Glybovski, St. Petersburg (RU); Dmitry Vitalievich Tatarnikov, Moscow (RU); Mikhail Andreevich Siganov, St. Petersburg (RU)

(21) Appl. No.: 17/436,604

(22) PCT Filed: Mar. 2, 2021
(86) PCT No.: PCT/RU2021/000088

§ 371 Date: Sep. 5, 2021

(51) Int. Cl. H01Q 9/04; H01Q 1/52

(52) U.S. Cl. CPC H01Q 9/0464; H01Q 1/521

(57) ABSTRACT

Antenna system includes an axially symmetric ground plane; a circular disc patch radiator positioned parallel to the ground plane; and a circular ring patch radiator positioned parallel to the ground plane and shorted to the ground plane using a cylindrical conductor at its inner radius; both radiators have the common axis of rotational symmetry; each radiator is excited with its own vertical metal pin, and both radiators are located at same height above the ground plane; and an axially symmetric capacitive decoupling element connecting a center of the disc patch to a center of the ground plane. Each vertical metal pin goes through the ground plane using through holes, and each vertical metal pin has a impedance matching network connected to it, and wherein the impedance matching network is connected to its transmission line section. The disc patch and the ring patch are isolated from the ground plane with dielectric.

### BACKGROUND OF THE INVENTION

### Field of the Invention

The present invention relates to antennas, and, in particular, to diversity patch antennas.

### Description of the Related Art

Patch antennas are used in various radiofrequency systems where typically a radiation pattern is to be created mainly in a single hemisphere. The applications of such antennas include ground satellite navigation systems (GPS, GLONASS, GALILEO, etc.) and wireless communication systems (WLAN, 3G, LTE, etc.).

Dual-feed antennas are required to provide several services that operate at two distinct frequencies, for instance, to combine two communication bands in the same system. In this case, the radiation patterns at different frequencies should have the same shape. Another case is forming two radiation patterns with different shapes at two different frequencies. This option allows the antenna system to provide two different services, e.g., to cover one satellite navigation band and one communication band. Finally, an important case is when two radiation patterns of different shapes are to be implemented at the same frequency. This possibility, called the radiation-pattern diversity, allows receiving signals from a statistical multipath radio channel employing two radiation patterns associated with two isolated receivers. Such antenna systems are applicable in SIMO and MIMO compact terminals.

One of the difficulties in designing a dual-feed patch antenna is to obtain a sufficient level of isolation between the ports, which depends on the application. In practice, for compact terminals, it is hard to achieve isolation of better than −15 dB when operating at the same polarization for both channels. The coupling between two matched ports deteriorates reception diversity, limits the radiation efficiency, and, in the case of separated bands, leads to undesirable cross-talk.

Patch antennas of different shapes are commonly low-profile structures that benefit from small thickness, the possibility of using the printed-circuit-board (PCB) technology, and convenience of integration with printed networks and electronics. Such antennas can be implemented by placing a thin metal patch of a particular shape (most often rectangular or circular) on a grounded dielectric slab (a substrate backed by a metal ground plane). When both required radiation patterns are mostly axially symmetric with respect to the normal to the patch plane (omnidirectional) and two receivers both have single inputs, one of the suitable designs of a dual-feed antenna system is a combination of a circular disc and a circular ring patch radiators with one feed per radiator. Both patch radiators support the excitation of a set of their resonant modes. Each mode has its resonant frequency and is associated with a specific shape of the radiation pattern as a function of the elevation angle in the upper hemisphere.

Each mode can be tuned to the target frequency in both disc and ring patches by applying well-known techniques. For instance, one can tune the desirable mode by varying the dielectric permittivity of the substrate, i.e., a dielectric slab between the corresponding patch and the ground plane.

A dual-feed antenna system based on stacked circular-patch radiators in a dual-feed configuration, where one radiator located in the center has a disc configuration and the other one located at the periphery has a ring configuration shortened to the ground at the inner radius with one probe feed per radiator was described in IEEE Antennas and Propagation Magazine, Vol. 50, No. 2, April 2008, incorporated herein by reference in its entirety. This combined antenna system is simple to fabricate and tune for the single- and dual-frequency operation while having the advantage of using different excited modes of both the disc and ring.

However, the isolation between the feeds is determined by the radial distance between them, while both their positions are explicitly determined by the requirement to obtain impedance matching and cannot be freely changed. As a result, the isolation is typically in the range of −20 to −15 dB even in the case of different radiation patterns created at the same frequency. The specified levels can be insufficient in some applications. Moreover, the isolation level further worsens when miniaturizing the antenna system (e.g., by increasing the dielectric permittivity of the substrate) and in the case of similar radiation patterns created. The above design does not have any degrees of freedom for decoupling the feeds.

The proposed technical solution is intended at solving the problem of mutual coupling reduction in combined dual-feed omnidirectional antennas operating at one or two frequencies and composed of a disc and shortened ring patch radiators.

### SUMMARY OF THE INVENTION

A dual-feed antenna system with improved in-band or off-band isolation of feeds is proposed, comprising a disc patch radiator and a ring patch radiator both placed over a ground plane. The patch radiator is connected at the position of the first feed through a matching network to an electronic circuit, and a ring patch radiator placed over its ground plane and shortened to it at the inner radius, and connected at the position of the second feed through a matching network to the other electronic circuit.

The disc and ring radiators can be located at the same height over the ground plane by placing flat metal sheets of the corresponding shapes over a dielectric layer (a substrate). The substrate isolates both metal shapes located in the same plane from the metal ground plane. In this case, the portion of the dielectric layer between the disc and the ground and between the ring and the ground generally have different values of dielectric permittivity.

The disc and/or ring patch resonators can be alternatively made by cutting the corresponding shapes from metal sheet and placing them at the same height over the ground using thin isolating holders (e.g., plastic posts or screws). In this particular case, both dielectric portions can be an air substrate. The antenna system can also have dual-stage (stacked) implementation. In this case, the disc and ring radiators can be placed at different heights over the primary ground plane while the ring resonator on the bottom can be combined with the secondary ground plane for the disc patch placed on the top.

At the first design step, both radiators should be tuned to the target operational frequencies according to the existing approaches, see IEEE Antennas and Propagation Magazine, vol. 50, no. 2, pp. 197-205, April 2008, incorporated herein by reference in its entirety, and IEEE Antennas and Wireless Propagation Letters, vol. 9, pp. 562-565, 2010, incorporated herein by reference in its entirety. For the ring radiator, one of the available resonant modes can be preferred depending on the required radiation pattern (e.g., TM₀₁, TM₁₁, or higher-order modes). For the disc radiator, mode TM₁₁ is assumed to be used, to provide a radiation pattern with the maximum in the normal direction. Both the disc and ring resonators are excited by probe feeds (vertical metal pins) that are connected to two different electronic circuits directly or through a matching network using coaxial or microstrip transmission lines.

At the second design step, both feeds should be impedancely matched using approaches known in the art, see IEEE Antennas and Propagation Magazine, vol. 50, no. 2, pp. 197-205, April 2008, incorporated herein by reference in its entirety, for instance, by varying the position of each probe relative to the central axis of the antenna system, or by applying additional matching networks comprising single lumped elements or L-, Pi-, T-type circuits, or corresponding stubs, or impedance transformers (distributed circuits).

At the third design step, a decoupling element with shunt electric capacity is introduced and incorporated at the center of the antenna system. This element should be placed symmetrically with respect to the axis of the antenna system and connect the center of the disc radiator to the center of its nearest ground. The element can be a lumped capacitor (of SMD or other suitable form) or can be implemented as a constructive capacitance between axially symmetric conductors one of which connected to the disc and the other one connected to the nearest ground. The conductors of the capacitive element can be separated by an insulator to increase the shunt capacity, or, alternatively, by air. Another option is a vertical conductor that is connected to the ground and/or to the disc through the constructive capacitance of an axially symmetric cap placed parallel to the ground/disc. The space between the metal cap and the ground/disc can be filled with an insulator or air.

To increase the value of the element's capacity, a dielectric insulator can be inserted into the gap between the above-mentioned conductors. The value of the capacity should be adjusted, e.g., by choosing the dielectric permittivity of the insulator or the horizontal size of the cap, until the transmission coefficient between two feeds reaches a minimum at the target frequency. After the tuning, matching and decoupling steps the antenna system will operate at the same frequencies as before decoupling with only small distortions of the obtained radiation patterns, but with significantly improved isolation of two feeds.

The obtained decoupling improvement in the proposed invention is achieved thanks to compensation of mutual coupling between the individually fed disc and ring radiators, which results from interaction of two modes excited in each radiator. The transmission coefficient at the target frequency can be minimized by means of changing the resonance position of the TM₀₁ mode of the disc radiator via adjusting capacity of the decoupling element. When changing the capacitance a sharp spectral minimum in the transmission coefficient corresponding to the resonance of TM₀₁ mode of the disc resonator is moved until the coupling is minimized at the target frequency. In the decoupled condition of the proposed antenna system, both TM₀₁ and TM₁₁ modes exist in a certain combination in both radiators. Moreover, the coupling between the radiators via TM₀₁ modes cancels out their coupling via TM₁₁ modes.

Note that a method of tuning TM01 mode of a disc patch radiator by changing the capacity of a confined capacitive element connecting the center of the disc with the center of its ground plane is known, see IEEE Antennas and Wireless Propagation Letters, vol. 9, pp. 562-565, 2010, incorporated herein by reference in its entirety. The capacitive element can be used to tune TM₀₁ mode independently from TM₁₁ of the same radiator. Using two distinct radiators instead of one gives more degrees of freedom in choosing the frequencies at which two different or similar radiation patterns are created by the antenna system. In the proposed invention central capacitive element is first introduced into an antenna system with two radiators. In contrast to the conventional art, the capacitive element is not used here to tune the radiation frequency of the disc, but to involve its additional mode, granting the decoupling between the disc and ring radiators.

Additional features and advantages of the invention will be set forth in the description that follows, and in part will be apparent from the description, or may be learned by practice of the invention. The advantages of the invention will be implemented and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE ATTACHED FIGS.

The accompanying drawings, which are included to provide a further understanding of the invention and are incorporated in and constitute a part of this specification, illustrate embodiments of the invention and together with the description serve to explain the principles of the invention.

In the drawings:

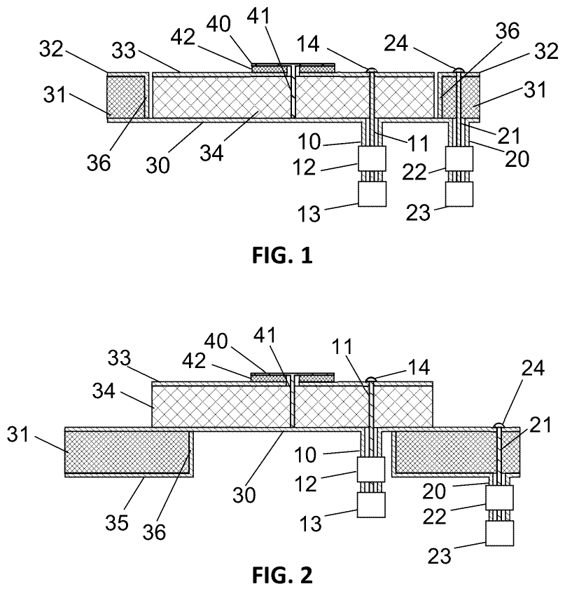

FIG. 1 shows a vertical-plane cross-section of a variant of the antenna system in which the disc and ring radiators are located at the same stage having a common ground plane.

FIG. 2 shows a vertical-plane cross-section of a variant of the antenna system in which the disc and ring patch radiators are placed at different levels.

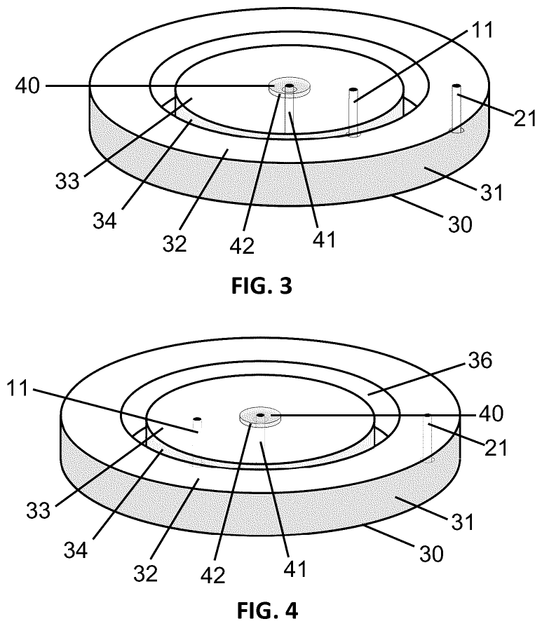

FIG. 3 illustrates the same antenna system as in FIG. 1 in a perspective view.

FIG. 4 illustrates the same antenna system as in FIG. 1 and FIG. 3 in a perspective view, where two probe feeds are located on the opposite sides from the axis of the antenna system.

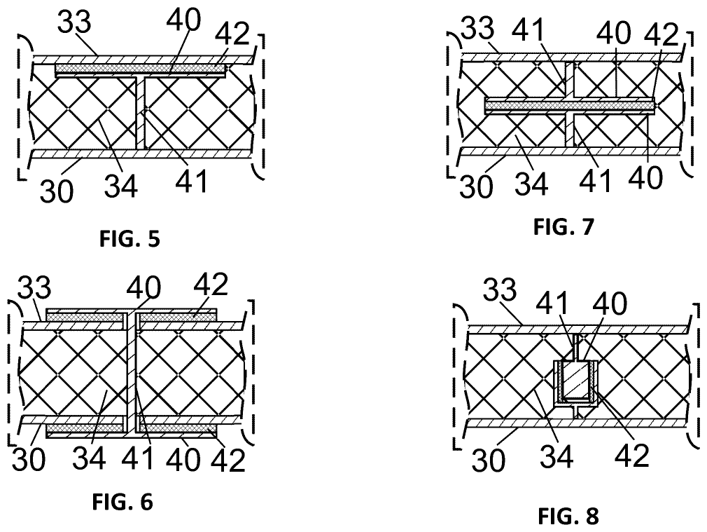

FIGS. 5-7 illustrate designs of the decoupling capacitive element consisting of two parallel thin cylindrical caps placed parallel to the disc patch and the ground plane with dielectric spacer insulating the caps from each other or isolating each cap from the ground and disc patch (in a particular case—air spacers can be used).

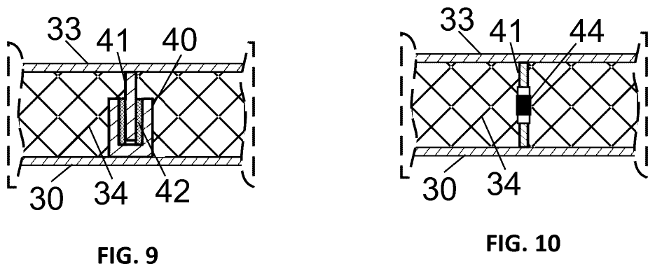

FIGS. 8-9 illustrate designs of the decoupling capacitive element, where a metal cylinder connected to the disc patch is placed into a cylindrical notch in a conductor connected to the ground with a dielectric spacer between the two conductors (in a particular case—air spacer).

FIG. 10 shows an implementation of the decoupling element as a lumped capacitor connected between the center of the disc patch and the ground plane.

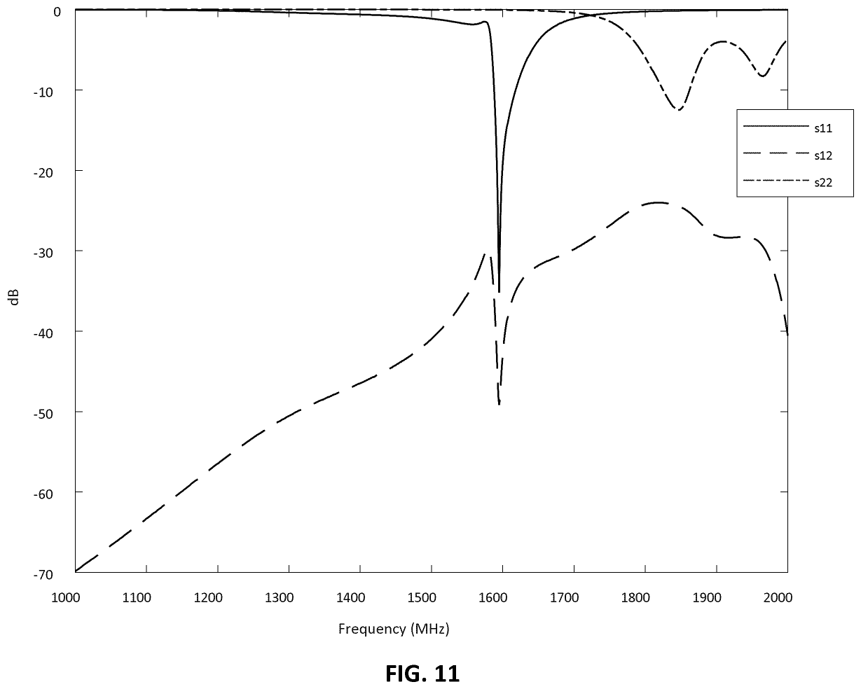

FIG. 11 presents an example of calculated S-parameters for the proposed single-stage antenna system with isolated feeds, where the inner disc radiator is tuned to the frequency of 1595 MHz and the outer shortened ring radiator is tuned to the frequency of 1843 MHz.

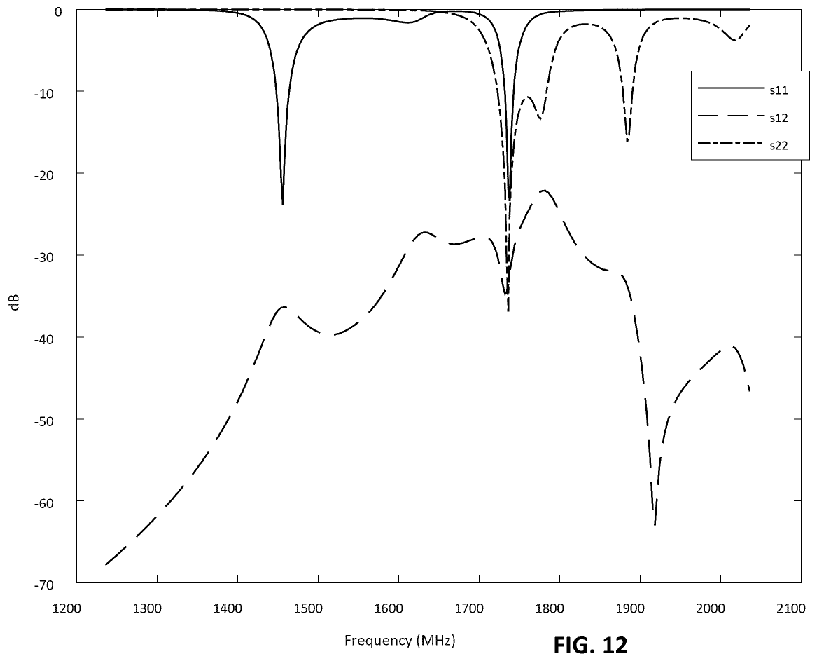

FIG. 12 presents an example of calculated S-parameters for the proposed single-stage antenna system with isolated feeds, where both radiators are tuned to the same frequency of 1736 MHz and matched obtaining the reflection coefficient level of better than −10 dB.

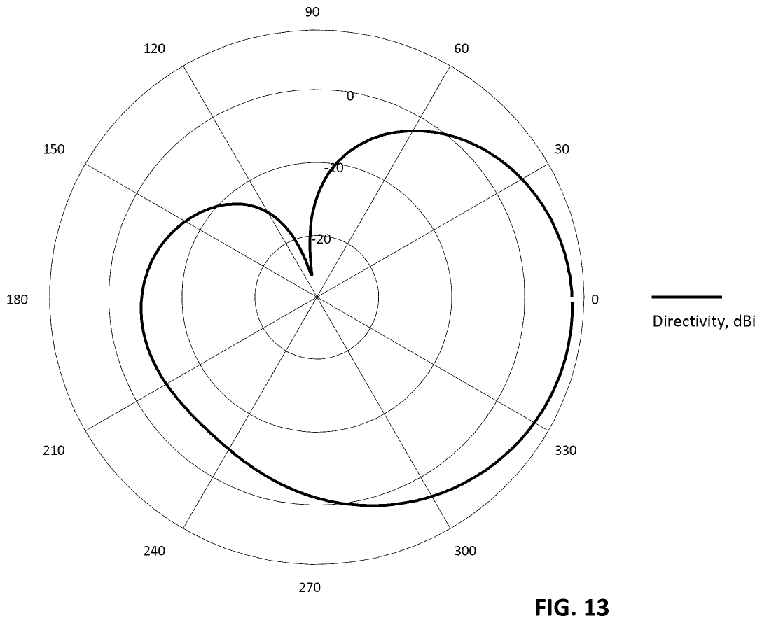

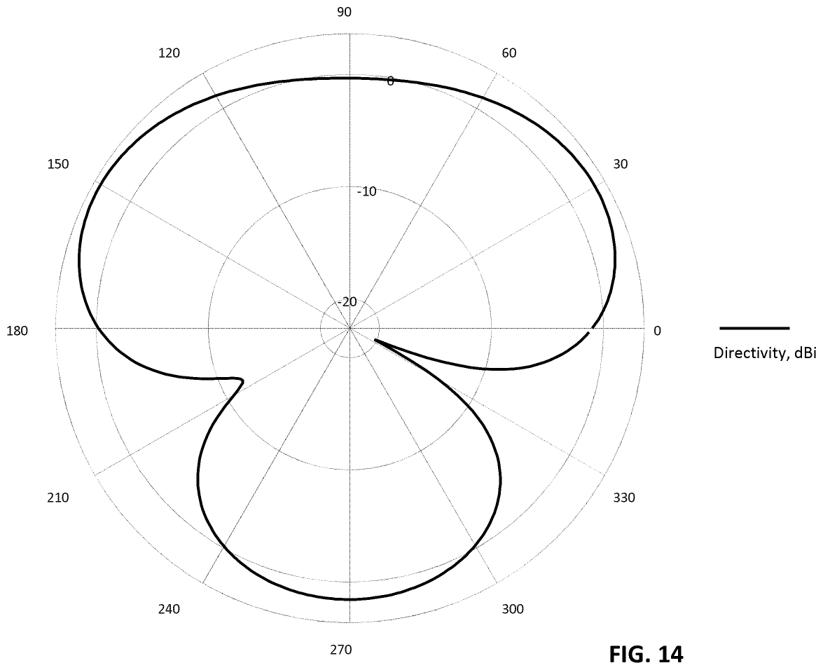

FIGS. 13-14 show the calculated radiation patterns (directivity in dBi) in the vertical plane (containing the axis of the antenna system and the probe feeds) for the proposed single-stage antenna system decoupled at 1595 MHz, in which the inner disc radiator is tuned to the frequency of 1595 MHz, while the outer ring radiator is tuned to the frequency of 1843 MHz.

FIG. 13 shows the calculated radiation pattern (directivity in dBi) when the feed of the disc patch is driven at 1595 MHz.

FIG. 14 shows the calculated radiation pattern (directivity in dBi) when the feed of the ring patch is driven at 1843 MHz.

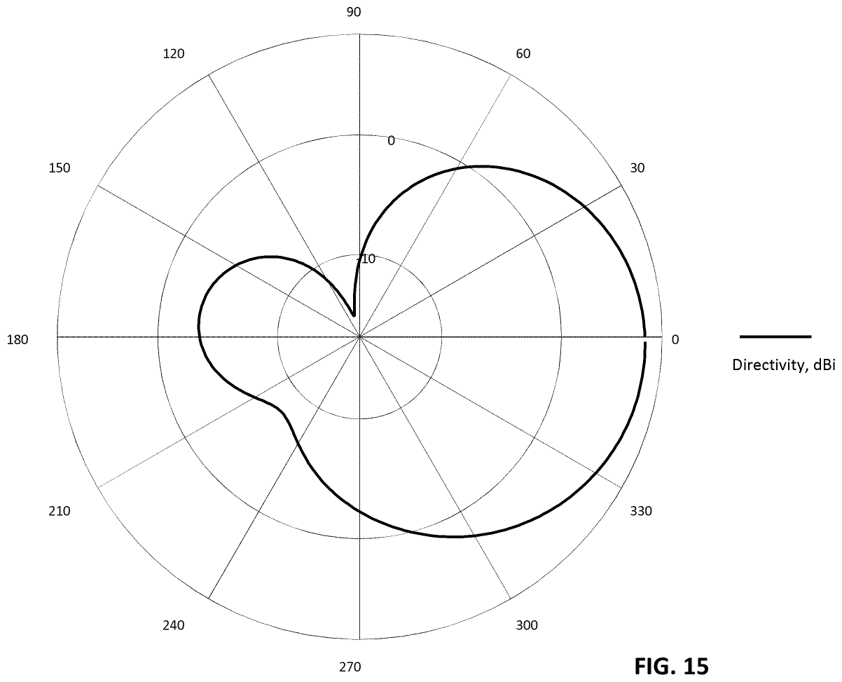

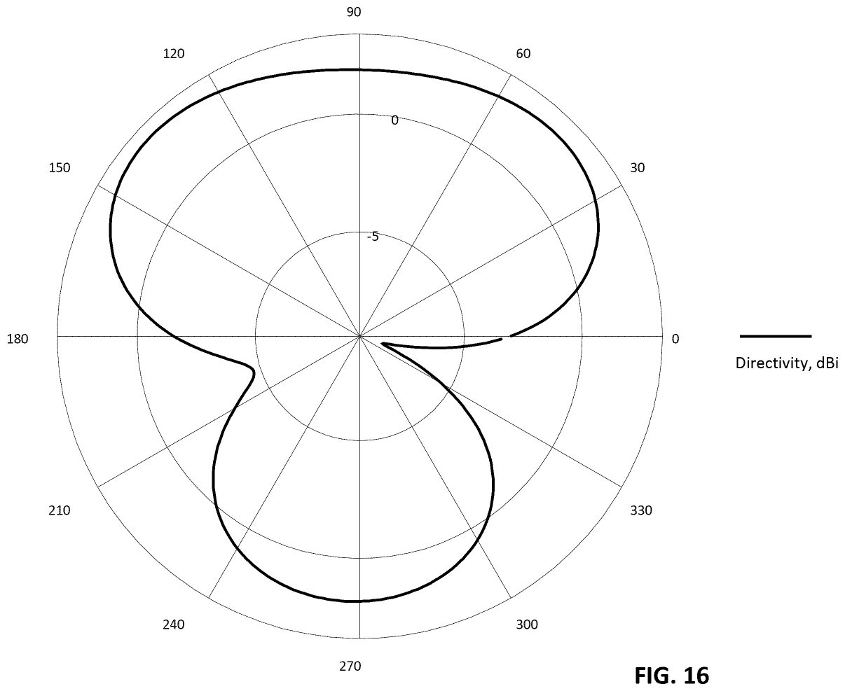

FIGS. 15-16 show the calculated radiation patterns (in dBi) in the vertical plane (containing the axis of the antenna system and the probe feeds) for the proposed single-stage antenna system decoupled at 1736 MHz, in which both radiators are tuned to the same frequency.

FIG. 15 shows the calculated radiation pattern (directivity in dBi) when the feed of the disc patch is driven at 1736 MHz.

FIG. 16 shows the calculated radiation pattern (directivity in dBi) when the feed of the ring patch is driven at 1736 MHz.

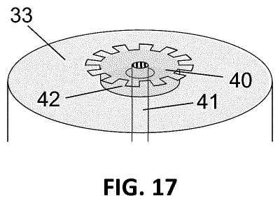

FIG. 17 shows the implementation of the decoupling element in which the capacitive cap is connected to the center of the ground plane of the disc patch by a vertical metal post going through a hole in the center of the disc patch, and the cap has a tooth-wheel shape instead of a circular shape.

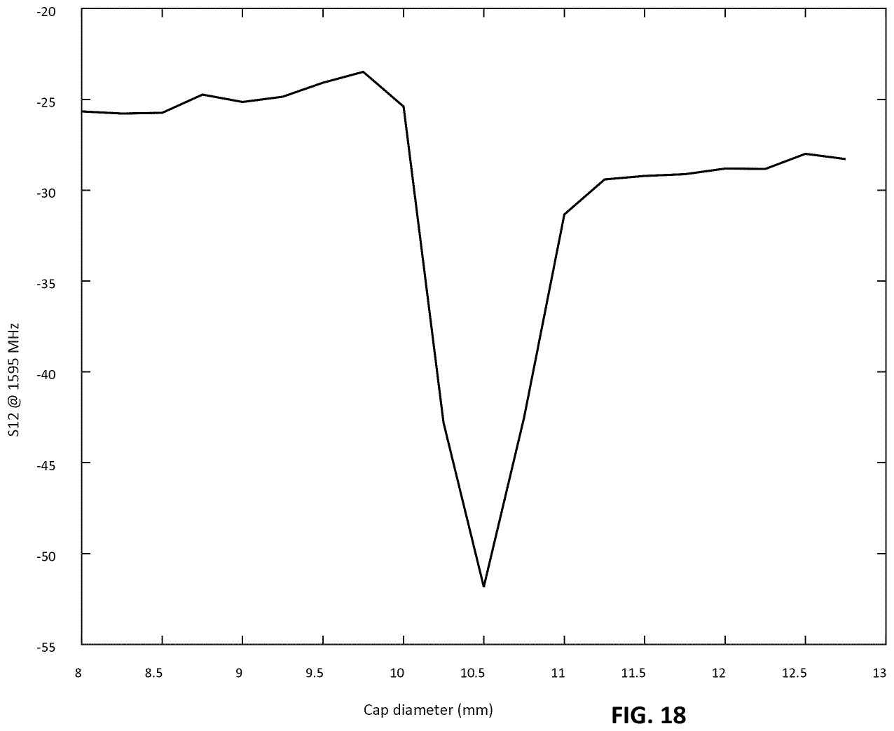

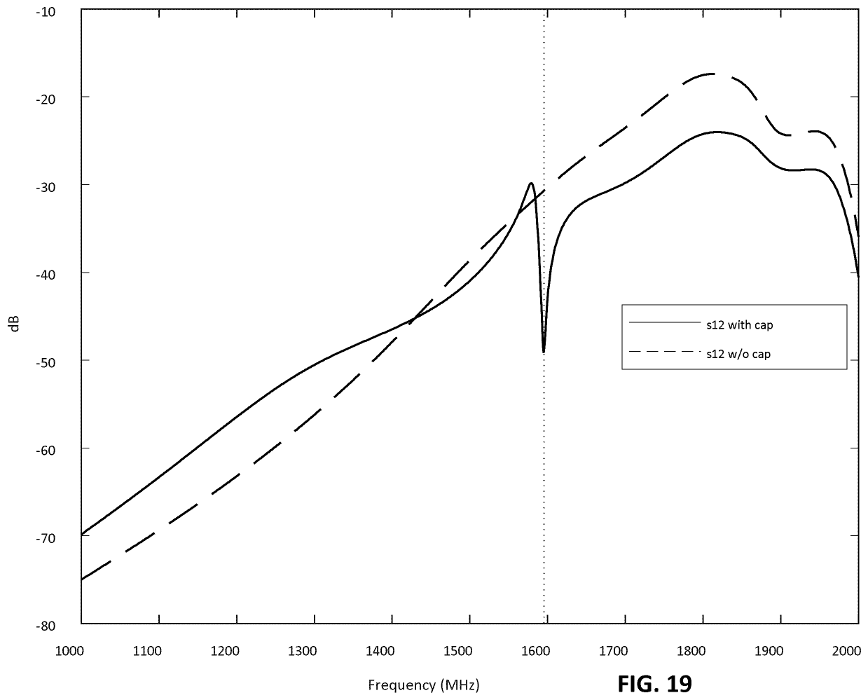

FIG. 18 shows the calculated dependence of the transmission coefficient S₁₂ (non-diagonal scattering matrix coefficient, in dB) between the matched feeds of the disc and ring radiators of the antenna of FIG. 1 on the diameter of the cap of the central decoupling element.

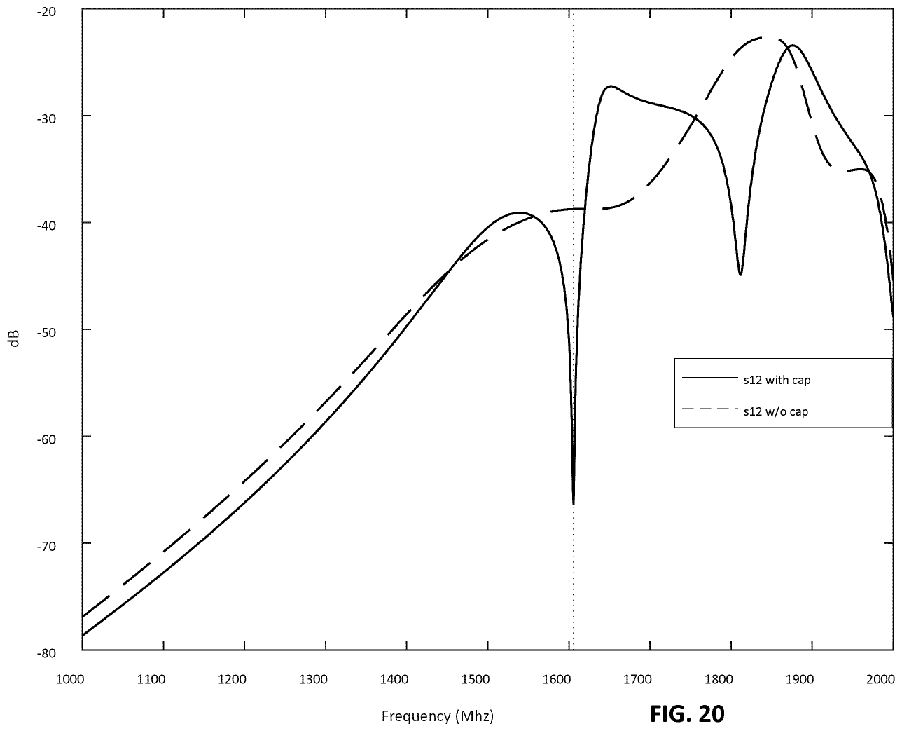

FIG. 19 shows the calculated parameter S₁₂ with and without the decoupling element for the case when two probe feeds in the disc and ring radiators are placed on the same side from the axis of the single-stage antenna configuration (as shown in FIG. 3).

FIG. 20 shows the calculated parameter S₁₂ with and without the decoupling element for the case when two probe feeds in the disc and ring radiators are placed on the opposite sides with respect to the axis of the single-stage antenna configuration (as shown in FIG. 4).

### DETAILED DESCRIPTION OF EMBODIMENTS OF THE INVENTION

Reference will now be made in detail to the embodiments of the present invention, examples of which are illustrated in the accompanying drawings.

The single-stage and dual-stage configurations of the proposed antenna system are described in FIGS. 1-4. The proposed antenna system contains two patch radiators, i.e., a disc radiator 33, and a ring radiator 32. Both radiators are axially-symmetric shapes and placed so that they have the same rotation axis. Both radiators can be cut from a metal plate made with thickness typically from 0.2 to 2 mm. Thicker metal plates do not improve radiation properties but make the antenna system heavier. Thinner metal layers such as copper or aluminum foil of thicknesses 10-200 microns can be used for both radiators. In this case, the foil can be deposited on the top surface of the dielectric substrates 31 of the ring and 34 of the disc radiator.

The metal plate can be preferred in the particular case of an air substrate. Metal foil thinner than 10 microns should not be used due to the skin depth effect and higher losses. The same two methods can be used to implement ground plane 30, which is common for two radiators in the single-stage configuration (FIG. 1).

The dual-stage configuration shown in FIG. 2 contains two individual ground planes 35 (primary ground plane) and 30 (secondary ground plane) located at different stages, which belong to two different radiators. In FIG. 2 the ring is on the bottom and the disc is on the top, while the ring patch is combined with the secondary ground plane for the disc patch; this design is more flexible and gives one more freedom in tuning because the inner radius of the ring is not limited by the outer radius of the disc.

The above-described two methods can be applied to implement both ground planes 35 and 30. In both the single- and dual-stage configurations, in contrast to the disc resonator, the ring one is shortened to its nearest ground plane with a cylindrical metal wall 36. This wall can be also implemented with the same methods as the ring and disc radiators.

Typically the size of any antenna system is limited by a given embodiment. Despite larger sizes provide higher radiation efficiency, the external diameter of the system and its total height are usually limited from above. For the fixed dimensions of the disc and ring radiators, the resonant frequencies can be tuned by filling the space between each resonator and the nearest ground plane with dielectric materials. With this goal in mind, a cylindrical dielectric body 34 is placed between disc radiator 33 and ground plane 30. Similarly, substrate 31, a dielectric hollow cylinder is placed between the ring radiator and the ground plane (30 in the single-stage configuration or 35 in the dual-stage configuration). The substrates also improve mechanical robustness of the antenna system.

The disc radiator is fed by the probe feed 11 connected through transmission line 10 to matching network 12 (if required) and electronic circuit 13. The ring radiator is fed by the probe feed 21 connected through transmission line 20 to matching network 22 (if required) and electronic circuit 23. The feeds are soldered to the radiators at connection points 14 and 24 for the disc and ring, correspondingly. Probe feed 11 is made of metal wire or strip connected to disc 33 at the solder point 14. Probe feed 21 can be implemented in the same way and it is connected to ring radiator 32 at the solder point 24.

In the single-stage configuration shown in FIGS. 1,3 and 4, both radiators 32 and 33 are located at the same height over the common ground plane 30. Ground plane 30 itself is a circular metal disc. In the dual-stage configuration shown in FIG. 2, disc and ring patch radiators are placed at different levels, where the ring is on the bottom and disc 33 is on the top. Here, the ring radiator is combined with the secondary ground plane 30 of disc radiator 33 within the same plate. At the same time, primary ground plane 35 of the ring is connected to secondary ground plane 30 at the inner radius of the ring by cylindrical metal wall 36. The dual-stage configuration is more flexible and gives one more freedom in tuning to two operational frequencies because the inner radius of the ring is not limited by the outer radius of the disc. However, the principle of operation of the second configuration is similar to one of the first configuration.

In both proposed configurations, it is possible to improve the decoupling between feeds 11 and 21 by inserting a decoupling element with shunt electric capacity. The element introduces capacitance effectively connected in between the center of disc radiator 33 and the center of the nearest ground plane 30. This connection is in shunt to a resonant cavity produced by the disc radiator and the ground plane. In the configurations illustrated in FIGS. 1-4 the decoupling element is formed by circular metal cap 40 located in parallel to radiator 33 and isolated from it by a cylindrical dielectric spacer 42, and vertical wire 41 connected to the center of ground plane 30. The capacitance of the decoupling element is due to a relatively narrow gap between two isolated conductors: cap 40 and disc radiator 33. The cap 40 is then connected by wire 41 going through a small hole in 33 to the center of ground plane 30. The electric capacity of the decoupling element can be calculated as C_{d}=ε₀εᵣS/d, where ε₀=8.85 pF/m, εᵣ is a relative permittivity of spacer 42, S and d are its area ant thickness, accordingly. The capacity can be varied to achieve decoupling by varying εᵣ, S, or d.

The introduced capacitive element allows to improve the decoupling when two probe feeds of the antenna system are located on the same side from the axis of the disc and ring radiators which is shown in FIG. 3. This corresponds to the worst-case mutual position of the feeds. One of two feeds, however, can be rotated by the angle of 180 degrees with respect to the axis without changing polarization of both radiators. In this case the cross-talk between the probes is slightly weaker, but still requires decoupling. In this case, shown in FIG. 4, the proposed capacitive element allows to decouple as well.

The procedure for designing the proposed antenna system with decoupled feeds consists of three steps: tuning the radiators, impedance matching and decoupling. All the steps are detailed below with explanation of particular methods and examples of numerical results.

STEP 1 (TUNING): Both radiators in the antenna system being placed over the common ground plane or individual ground planes form two separate resonators. Depending on the application the operational frequency can be the same for both radiators (diversity) or the radiators may be required to radiate at different frequencies (dual-band system). Accordingly, to achieve high radiation efficiency and maximize gain, both resonators must be tuned to the same frequency or to different frequencies. Both the disc and ring patch resonators provide multiple resonances related to their different eigenmodes. Each eigenmode has its individual electromagnetic field configuration and provides at its resonance an individual shape of the radiation pattern. Therefore, for both the disc and ring one can prefer one of its eigenmodes, which resonance is to be tuned to the operational frequency (or two frequencies). The mode field configurations of the disc resonator are described in section 14.3.4 of Balanis, Constantine A., Antenna theory: analysis and design, John Wiley and Sons, 2005, incorporated herein by reference in its entirety. For the shortened ring patch the same can be found in V. Gonzalez-Posadas et al., IEEE Transactions on Antennas and Propagation, vol. 54, no. 6, pp. 1875-1879, 2006, incorporated herein by reference in its entirety.

In the ring radiator, one can prefer mode TM₀₁, TM₁₁, or higher-order modes to achieve a required radiation pattern. However, to use the proposed decoupling element, mode TM₁₁ must be selected for radiation of the disc radiator. The resonant frequencies of the disc patch depend on the diameter of disc 33, and relative permittivity of substrate 34. Depending on the size limitations in the application, one can tune the selected mode TM₁₁ of the disc patch using both parameters, according to well-known expressions (see Eqs. (14-67)-(14-68) in Balanis. For the limited diameter, the proper way to tune the disc patch is to adjust the dielectric permittivity of substrate 34. If the size has no limitation, an air substrate can be used. The height of substrate 34 is usually chosen from the range from 0.01 to 0.1 of the free-space operational wavelength to reach sufficiently large radiation efficiency. The latter is maximized by increasing the height according to expression. See (14-90) in Balanis. The resonant frequency of the ring patch can be found using, e.g., expressions (1-2) in V. Gonzalez-Posadas et al.

The frequency of each mode depends on the inner and outer diameter of ring 32 in the single-stage configuration, as well as on the permittivity of substrate 31. All the mentioned parameters can be used for frequency tuning depending on imposed size limitations. In the dual-stage configuration, the inner radius of ring 32 and its primary ground plane 35 can be made smaller than the outer radius of disc 33, which is an additional degree of freedom. The height of substrate 31 should be increased as much as possible to maximize the radiation efficiency of the ring radiator similarly to the case of the disc radiator. After both radiators are tuned separately they should be combined. After that, the resonant frequency of the both radiators needs to be slightly adjusted to compensate for the interaction.

STEP 2 (MATCHING): In both a disc and a ring patch, the distance from the axis to the probe feed should be chosen with the goal to obtain the best impedance matching between the radiators and their electronic circuits 13, 23. In the most of the cases, impedance matching can be achieved by adjusting the position of the probe based on the well-known methodology. Thus the position of feed 11 can be chosen based on the methods of section 14.5 in Balanis and the position of feed 21—based on the methods of section II-C in V. Gonzalez-Posadas et al.

In particular cases, when the real part of input impedance cannot reach the goal impedance even for the feed position at the edge of the corresponding radiator, additional matching networks 12, 22 may be required between the probes and the electronic circuits. Matching networks 12 and 22, in general, should be connected to the inputs of probe feeds 11, 21 by transmission-line sections 10, 20. The design of matching networks 12, 22 is done according to the available art and comprise lumped elements or an L-, Pi-, or T-type circuit, or corresponding stubs, or impedance transformers (distributed circuits). Transmission-line sections 10, 20 connected to the feeds 11, 21 can be coaxial or microstrip. In the examples given in FIGS. 1-2, the radiators are fed using coaxial cables, which consist of center wires connected to feeds 11 and 21 through special holes in the corresponding ground planes nearest to the radiator and or shields (outer conductors) connected to the corresponding ground plane.

STEP 3 (DECOUPLING): the capacitive decoupling element is installed to the center of the antenna system comprising disc and ring radiators in a single- or dual-stage configuration so that it connects the center of disc radiator 33 with the center of ground plane 30 through its capacitance. The capacity of the decoupling element is a parameter of the proposed element to be swept. In FIGS. 1-2 the decoupling element consists of circular cap 40 placed in parallel to disc radiator 33 and separated by dielectric spacer 42 from it, and a vertical wire 41 connected to the center of ground plane 30. In this case, the capacitance of the decoupling element is due to a narrow gap between 40 and 33 filled with dielectric.

The advantage of this form of the decoupling element is that it can be implemented using printed-circuit board (PCB), where spacer 42 is made of a PCB substrate and cap 40 is made by etching copper foil. Alternatively, cap 40 can be cut from a metal sheet, soldered to wire 41 and placed over a solid dielectric cylinder to realize spacer 42. The decoupling element with the same capacity as required for decoupling can be otherwise obtained with different axially-symmetric geometries illustrated in FIGS. 5-9 as well as by using a lumped circuit element (FIG. 10).

In comparison to the structure depicted in FIGS. 1-2, the structures of FIGS. 5, 7-10 have the advantage of internal location of the decoupling element and additional benefits as follows. The structure of FIG. 6 allows to disconnect the decoupling element from 33 and 30 at direct current (DC). The structure of FIG. 7 is more suitable in the case of air substrate 34 of disc radiator 33. The structures of FIGS. 8 and 9 allow making the horizontal dimensions of the decoupling element smaller for better compactness.

In the structure of FIG. 10, the decoupling element is based on lumped element 44, which is either a capacitor or a diode connected in the split of wire 41. This structure benefits from high available capacity values of lumped capacitors (e.g., of SMD capacitors) and can be used for electronically adjusting the decoupling frequency by applying static voltage between plates 33 and 30 (if a varactor diode is used).

Finally, in the structure of FIG. 17, the decoupling element has a cap 40 soldered to wire 41 going through hole in 33, where the cap has a shape of a toothed wheel. This structure has an advantage of precise controlling the capacity by adjusting the length of the tooth at the periphery of the cap. In each structure the capacity of the decoupling element should be adjusted until the transmission coefficient level between feeds at the inputs of matching networks 12 and 23 (or directly at the corresponding feeds, if the matching networks are absent) reaches a minimum at the decoupling frequency. The decoupling frequency can be the common operational frequency of the disc and ring radiators (in-band decoupling in the case of diversity application) or the operational frequency of the disc radiator (if two operational bands are used for the discs and ring, i.e., off-band decoupling).

The operational principle of the proposed decoupling element is as follows. The disc radiator radiates due to excitation of TM₁₁ mode, which can interact with the same mode of the ring radiator causing undesirable coupling. Depending on the frequency of the ring resonator, this coupling can be in-band (diversity application) or off-band (dual-band application). In order to compensate for the mutual coupling, the capacitive decoupling element is introduced in the disc radiator. This element does not affect the resonant frequency of its mode TM₁₁, but affects the resonant frequency of its mode TM₀₁. The latter has a minor effect on the radiation pattern of the disc radiator, but significantly affects the isolation of two radiators. By adjusting capacity of the decoupling element, TM₀₁ mode of the disc is brought to the frequency at which decoupling is to be achieved. With the optimal capacity, the additional coupling mechanism between modes TM₀₁ is introduced which cancels out the existing coupling mechanism via modes TM₁₁. This cancellation is possible even if TM₀₁ or TM₁₁ is the radiating mode of the ring radiator.

Below are two examples of the single-stage antenna system using the proposed capacitive element for off-band and in-band decoupling showing the corresponding numerically calculated characteristics.

Consider an example of off-band decoupling. The S-parameters shown in FIG. 11 and radiation patterns shown in FIGS. 13-14 are the numerically calculated properties of the proposed antenna system in the single-stage configuration (according to FIG. 1) with a radius of the disc radiator of 35 mm, an inner radius of the ring radiator of 36.5 mm, and an outer radius of the latter of 45 mm. The values of the dielectric permittivity of the disc and ring radiators are 1.8 and 21, respectively. The feeds of the disc and ring radiators are connected at the distance of 9.2 mm and 39.5 mm from the axis, respectively. With the above-mentioned parameters, the disc radiator is tuned and matched at the frequency of 1595 MHz, while the shortened ring radiator is tuned and matched at the frequency of 1843 MHz. These two frequencies correspond to GNSS and LTE bands. Both feeds are matched at the corresponding frequencies obtaining the reflection coefficient level of better than −10 dB. The optimal capacity of the decoupling element for the best decoupling at 1595 MHz is 0.51 pF.

As seen from FIG. 11, the method provides off-band decoupling with S₁₂ of better than −45 dB. The feeds are matched at the corresponding frequencies obtaining the reflection coefficient level of better than −10 dB. The decoupling frequency is 1595 MHz. The comparison of the transmission coefficient S₁₂ levels with and without the decoupling element is given in FIG. 19, where an improvement by at least 15 dB can be seen. The transmission coefficient achieves the level of −30 dB without decoupling at 1595 MHz, while the use of decoupling element allows reaching the level of −49 dB (the disc radiator is tuned and matched at 1595 MHz, while the ring radiator is tuned and matched at 1843 MHz). FIG. 20 shows that in the case where the probe feeds are located on the opposite sides with respect to the axis (FIG. 4), the initial transmission coefficient is lower and the isolation is better: −38 dB instead of −30 dB in the case with the feeds on the same side (FIG. 3).

However, as seen from FIG. 20, the decoupling can be further improved by more than 15 dB. The S₁₂ parameter achieves the level of −39 dB without decoupling at 1595 MHz, while the use of decoupling element allows to reaching the level of −66 dB (the disc radiator is tuned and matched at 1595 MHz, while the ring radiator is tuned and matched at 1843 MHz). Therefore, the proposed method is suitable for both arrangements of probe feeds.

FIG. 13 shows the radiation pattern created at 1595 MHz when the disc radiator is fed. Its shape resembles the cardioid shape with maximum radiation close to the broadside directions (to the zenith at zero angle) related to TM₁₁ mode mostly contributing to radiation.

FIG. 14 shows the radiation pattern created at 1843 MHz when the ring radiator is fed. This shape resembles the donut-shaped (monopole-like pattern) related to TM₀₁ mode mostly contributing to radiation with maximum radiation close to the plane of the antenna system. The optimal capacitance can be achieved with the decoupling element form depicted in FIGS. 1-2. Thus with air spacer 42 of a thickness 0.7 mm and permittivity 1, the required capacity of 0.51 pF for the smallest S₁₂ level can be achieved by choosing the diameter of cap 40 equal to 10.5 mm as seen in FIG. 18. This example shows the possibility to suppress an undesirable off-band coupling where, for example, a transmitting antenna in the higher band may affect the receiving antenna in the lower band. This could be a real scenario of combined antenna systems used for navigation and wireless communications.

Let us now consider an example of in-band decoupling. The S-parameters shown in FIG. 12 and radiation patterns shown in FIGS. 15-16 are the numerically calculated properties of the single-stage configuration of the antenna system having the same geometric parameters as in the previous example, but with different permittivity values of the substrates, namely 1.8 and 18.8 for the disc and ring radiators, accordingly. With these parameters, both radiators are tuned to the frequency of 1736 MHz. By choosing the distance of the feeds from the axis of 9.3 and 40.4 mm for the disc and ring, correspondingly, impedance matching was obtained at the same frequency. The optimal capacity of the decoupling element was found to be 0.58 pF.

FIG. 12 shows that both feeds are matched at 1736 MHz, while the level of S₁₂ at this frequency due to the decoupling element is as low as −35 dB. For a comparison, it should be stressed that without decoupling the in-band level of S₁₂ at the same frequency is only −9 dB (in the worst-case arrangements of probe feeds shown in FIG. 3).

FIG. 15 shows the radiation pattern created at 1736 MHz when the disc radiator is fed. Its shape resembles the cardioid shape with maximum radiation close to the broadside (to the zenith at zero angle) related to TM₁₁ mode mostly contributing to radiation. FIG. 16 shows the radiation pattern created at the same frequency when the ring radiator is fed. This shape resembles the donut shape related to TM₀₁ mode mostly contributing to radiation with maximum radiation close to the plane of the antenna system. The illustrated in-band decoupling scenario is advantageous for enhancing the performance of diversity antenna terminals operating in one of LTE bands.

Having thus described the different embodiments of a system and method, it should be apparent to those skilled in the art that certain advantages of the described method and apparatus have been achieved. It should also be appreciated that various modifications, adaptations, and alternative embodiments thereof may be made within the scope and spirit of the present invention. The invention is further defined by the following claims.

What is claimed is:

1. An antenna system comprising:
an axially symmetric ground plane;
a circular disc patch radiator positioned parallel to the ground plane; and
a circular ring patch radiator positioned parallel to the ground plane and shorted to the ground plane using a cylindrical conductor at its inner radius,
wherein both radiators have a common axis of rotational symmetry; and each radiator is excited with its own vertical metal pin, and both radiators are located at same height above the ground plane; and
an axially symmetric capacitive decoupling element connecting a center of the circular disc patch radiator to a center of the ground plane.

2. The antenna system of claim 1, wherein each vertical metal pin goes through the ground plane using through holes, and wherein each vertical metal pin has a impedance matching network connected to it, and wherein the impedance matching network is connected to its transmission line section.

3. The antenna system of claim 1, wherein the circular disc patch radiator and the circular ring patch radiator are isolated from the ground plane with dielectric insulators.

4. The antenna system of claim 1, wherein the capacitive decoupling element includes a vertical conductor connected on the top side to a circular conductive cap which is placed parallel to the circular disc patch radiator and on the bottom side to the center of the ground plane, and wherein the circular conductive cap is isolated from the circular disc patch radiator.

5. The antenna system of claim 1, wherein the capacitive decoupling element includes a vertical conductor connecting an upper circular metal cap which is placed above the circular disc patch radiator and isolated from the disc patch radiator to a lower circular metal cap, which is placed below the ground plane, and isolated from the ground plane.

6. The antenna system of claim 1, wherein the capacitive decoupling element includes two metal surfaces with a dielectric therebetween, and forming a capacitor, wherein the two metal surfaces are connected to the circular disc patch radiator on one side and to the ground plane on the other side.

7. The antenna system of claim 1, wherein the capacitive decoupling element includes two coaxial conductors with a dielectric therebetween, all located between the circular disc patch radiator and the ground plane.

8. The antenna system of claim 1, wherein the capacitive decoupling element includes a vertical conductor connected to a conductive cap having a shape of a toothed wheel, which is parallel to the circular disc patch radiator, and wherein the conductive cap is isolated from the circular disc patch radiator.

9. The antenna system of claim 1, wherein the capacitive decoupling element is a lumped capacitor or a varactor connected to the circular disc patch radiator on one side and to the ground plane on the other side.

10. An antenna system comprising:
an axially symmetric primary ground plane;
a circular disc patch radiator positioned parallel to the primary ground plane; and
a circular ring patch radiator positioned parallel to the primary ground plane and shorted to the primary ground plane using a cylindrical conductor at its inner radius,
wherein both radiators have the common axis of rotational symmetry, and each radiator is excited with its own vertical metal pin; and
an axially symmetric capacitive decoupling element,
wherein the circular disc patch radiator is further elevated and placed above the plane of the circular ring patch radiator, and the circular ring patch radiator is combined with a disc plate of the same radius as an inner radius of the ring patch radiator so as to function a secondary ground plane for the disc patch radiator, and the capacitive decoupling element connects a center of the disc patch to a center of the secondary ground plane, and wherein the ring patch radiator is placed above the primary ground plane.

11. The antenna system of claim 10, wherein the vertical metal pin connected to the ring patch radiator goes through the primary ground plane using a through hole, and wherein the vertical metal pin connected to the disc patch radiator goes through the secondary ground plane using a through hole, and wherein each vertical metal pin has an impedance matching network connected to it, and wherein the impedance matching network is connected to its transmission line section.

12. The antenna system of claim 10, wherein the capacitive decoupling element includes a vertical conductor connected on the top side to a circular conductive cap which is placed parallel to the circular disc patch radiator and on the bottom side to the center of the secondary ground plane, and wherein the circular conductive cap is isolated from the circular disc patch radiator.

13. The antenna system of claim 10, wherein the capacitive decoupling element includes a vertical conductor connecting an upper circular metal cap which is placed above the circular disc patch radiator and isolated from the disc patch radiator to a lower circular metal cap, which is placed below the secondary ground plane, and isolated from the secondary ground plane.

14. The antenna system of claim 10, wherein the capacitive decoupling element includes two metal surfaces with a dielectric therebetween, and forming a capacitor, wherein the two metal surfaces are connected to the circular disc patch radiator on one side and to the secondary ground plane on the other side.

15. The antenna system of claim 10, wherein the capacitive decoupling element includes two coaxial conductors with a dielectric therebetween, all located between the circular disc patch radiator and the secondary ground plane.

16. The antenna system of claim 10, wherein the capacitive decoupling element includes a vertical conductor connected to a conductive cap having a shape of a toothed wheel which is parallel to the circular disc patch radiator, and wherein the conductive cap is isolated from the circular disc patch radiator.

17. The antenna system of claim 10, wherein the capacitive decoupling element is a lumped capacitor or a varactor connected to the circular disc patch radiator on one side and to the secondary ground plane on the other side.
